(19) United States
(12) Patent Application Publication
(10) Pub. No.: US 2009/0008592 A1
(43) Pub. Date: Jan. 8, 2009

(54) FUEL INJECTION VALVE

(75) Inventors: Ulrich Schoor, Stuttgart (DE); Michael Jupe, Ludwigsburg (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 11/908,676

(22) PCT Filed: Apr. 3, 2006
(86) PCT No.: PCT/EP06/61267

§ 371 Date: Sep. 14, 2007

(30) Foreign Application Priority Data
May 30, 2005 (DE) 10 2005 024 710.5

(51) Int. Cl. F16K 1/00

(52) U.S. Cl. 251/333; 239/584

(57) ABSTRACT

The invention relates to a fuel injection valve for fuel injection systems of self-igniting air-compression internal combustion engines. The fuel injection valve comprises an actuator, housed in a valve chamber, and a valve closing element that is actuated by the actuator by means of a valve needle. The valve closing element interacts with a valve face to give a sealing seat. The valve also comprises a transition piece that is attached to the actuator, and an expandable hose encompasses the periphery of the actuator and a part of the transition piece. The expandable hose is connected to the transition piece in an area of fastening.

### PRIOR ART

The invention relates to a fuel injection valve for fuel injection systems of internal combustion engines. In particular, the invention relates to an injector for fuel injection systems of air-compressing autoignition engines.

DE 198 56 202 A1 has disclosed a fuel injection valve with a piezoelectric actuator. In the known fuel injection valve, the actuator is situated in an actuator chamber; an actuator head and an actuator foot are attached to the actuator. The actuator situated in the actuator chamber can be cooled by means of a cooling air flowing through the actuator chamber. In order to protect the actuator from direct atmospheric humidity, the actuator body and its electrode supply lines are protected by means of an elastomer casing or a shrink-fit tube.

The fuel injection valve known from DE 198 56 202 A1 has the disadvantage that the actuator chamber must be sealed in relation to the fuel, thus increasing the volume of the fuel injection valve, and that at the ends of the actuator, atmospheric humidity can pass through the gap between the actuator and the actuator head or actuator foot and penetrate the active layers of the actuator, thus impairing the function of the actuator.

### ADVANTAGES OF THE INVENTION

The fuel injection valve according to the invention, with the defining characteristics of claim 1, has the advantage over the prior art that the actuator is reliably sealed by means of the stretch hood, which radially encompasses the actuator and also radially encompasses at least part of the transition piece. This seal allows the actuator to also be installed in a chamber of the fuel injection valve through which fuel flows; the stretch hood protects the actuator from dirt particles in the fuel. The stretch hood can also assure an electrical insulation in relation to the valve housing of the fuel injection valve.

Advantageous modifications of the fuel injection valve disclosed in claim 1 are possible by means of the steps taken in the dependent claims.

It is advantageous if the stretch hood is stretchable in an axial direction in at least one region of the actuator in order to permit an expansion of the actuator in the axial direction for the actuation of the valve closing element. The stretch hood can also be embodied as stretchable over its entire length. It is also possible for the stretch hood to be provided with several annular regions that are stretchable. According to another possible embodiment, the stretchability of the stretch hood is limited to the region of the actuator. The stretchability of the stretch hood has the advantage that the stretch hood essentially rests against the actuator both in the position of repose and when the actuator is being actuated, thus avoiding a malfunction caused by a possible flow of fuel past the actuator.

It is advantageous for the transition piece to be adapted to a cross-sectional shape of the actuator on a side on which the transition piece is attached to the actuator and for the transition piece to be rounded in the fastening region in which the stretch hood is attached to the transition piece. This prevents damage to the stretch hood even when the fuel is at a high pressure that acts on the stretch hood.

It is also advantageous for the transition piece to be embodied so that from the side on which the transition piece is attached to the actuator, a cross-sectional form of the transition piece transitions evenly into a cross-sectional form in the fastening region of the transition piece. For example, the cross-sectional form of the actuator can have several vertexes and in particular can be embodied as square. The transition piece on the actuator side is adapted to the cross-sectional form of the actuator so that the cross-sectional form of the transition piece likewise has a number of vertexes and in particular is embodied as square. The uniform transition to the cross-sectional form in the fastening region avoids the presence of sharp edges and preferably also sharp curvature radii in the axial direction in which the stretching forces of the stretch hood act on the attachment, thus preventing damage to the stretch hood during operation of the fuel injection valve.

The transition piece is advantageously embodied at least partially in the form of a cone and/or at least partially in the form of a truncated cone in the fastening region. In addition, the stretch hood preferably rests against the transition piece circumferentially in order to achieve a form-locked connection between the stretch hood and the transition piece in the fastening region. This produces an advantageous attachment of the stretch hood, which assures a reliable sealing of the interior of the stretch hood, i.e. of the actuator, in relation to the outside region of the stretch hood, i.e. the fuel, especially when the actuator is being actuated and/or when the stretch hood is subjected to the pressure of the fuel.

It is also advantageous for the stretch hood to be attached to the transition piece in the fastening region by means of a fastening ring that at least partially encompasses the stretch hood and the transition piece. This makes it possible to affix the stretch hood to the transition piece. In addition, the fastening ring—particularly in the unpressurized state of the fuel injection valve—produces an additional seal of the interior of the stretch hood in relation to surrounding media.

It is also advantageous for a transition piece to be provided at both ends of the actuator, one embodied as the actuator head and the other embodied as the actuator foot. This makes it possible to embody the actuator, along with the transition pieces and the stretch hood, in the form of a modular subassembly, thus simplifying assembly of the fuel injection valve. This also makes it possible to achieve a reliable seal of the actuator at both ends.

### DRAWINGS

Preferred exemplary embodiments of the invention will be explained in detail in the description below, in conjunction with the accompanying drawings.

FIG. 1 shows an axial section through a first exemplary embodiment of the fuel injection valve according to the invention;

FIG. 2 shows a transition piece of a fuel injection valve according to a second exemplary embodiment of the invention;

FIG. 3 shows a fastening sleeve for fastening a stretch hood according to a third exemplary embodiment of the invention, and

FIG. 4 is a sample depiction of a transition piece of a fuel injection valve according to a fourth exemplary embodiment of the invention.

### DESCRIPTION OF THE EXEMPLARY EMBODIMENTS

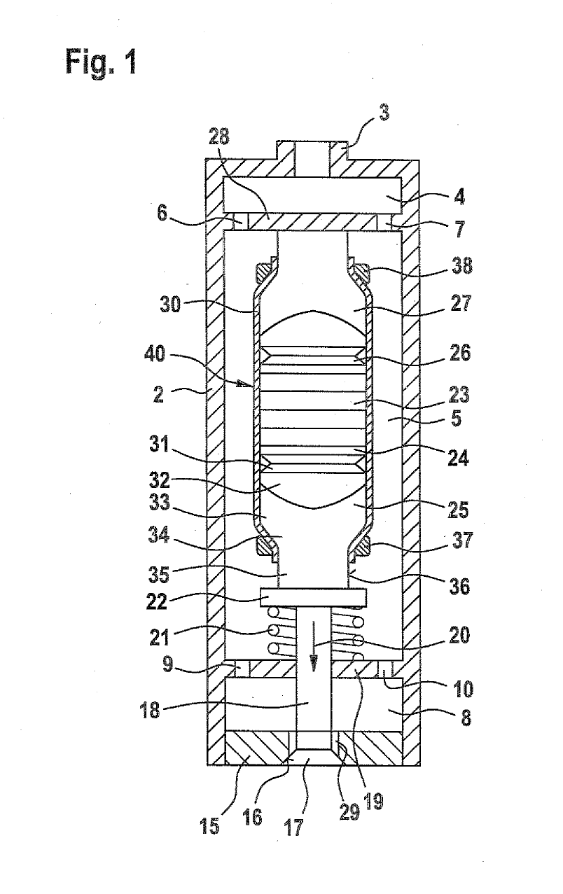

FIG. 1 shows a first exemplary embodiment of a fuel injection valve 1 of the invention. The fuel injection valve 1 can in particular serve as an injector for fuel injection systems of air-compressing autoignition internal combustion engines. In particular, the fuel injection valve 1 is suitable for commercial vehicles or passenger vehicles. A preferred use of the fuel injection valve 1 is for a fuel injection system with a common rail that supplies highly pressurized diesel fuel to a number of fuel injection valves 1. The fuel injection valve 1 according to the invention, however, is also suitable for other specific applications.

The fuel injection valve 1 has a valve housing 2 comprised of a number of parts and has a fuel inlet fitting 3 connected to the valve housing 2. A fuel line (not shown) can be connected to the fuel inlet fitting 3 in order to introduce fuel into an inner chamber 4 of the valve housing 2. The inside of the valve housing 2 also contains an actuator chamber 5 that can be embodied in the form of a high-pressure bore in the valve housing 2. The actuator chamber 5 communicates with the inner chamber 4 via through openings 6, 7. The inside of the valve housing 2 also contains a fuel chamber 8 that communicates with the actuator chamber 5 via through openings 9, 10. The inner chamber 4, the through openings 6, 7, the actuator chamber 5, and the through openings 9, 10 constitute a fuel line extending from the fuel inlet fitting 3 into the fuel chamber 8 in order to convey fuel, which has traveled into the fuel injection valve 1 via the fuel inlet fitting 3, into the fuel chamber 8. Highly pressurized fuel is therefore also present in the actuator chamber 5 during operation of the fuel injection valve 1.

The valve housing 2 is connected to a valve seat body 15 on which a valve seat surface 16 is provided. The valve seat surface 16 cooperates with a valve closing element 17 to form a sealing seat; in the initial state shown, the sealing seat is closed. The valve closing element 17 is integrally joined to a valve needle 18 that is guided in an axial direction 20 by means of a valve needle guide comprised of a housing part 19. The housing part 19 contains the through openings 9, 10. One end of a valve spring 21 rests against the housing part 19 and the other end rests against a pressure plate 22 that is attached to the valve needle 18 so that the force of the valve spring 21 exerts a closing force on the sealing seat formed by the valve closing element 18 and the valve seat surface 16.

A piezoelectric actuator 23 comprised of a number of active layers is provided in the actuator chamber 5. At a first end 24, the actuator 23 rests against a transition piece 25 that is attached to the actuator 23. At a second end 26 of the actuator 23, the actuator 23 rests against a transition piece 27 that is attached to the actuator 23. In the exemplary embodiment shown, the transition piece 27 is embodied in the form of an actuator foot and the transition piece 25 is embodied in the form of an actuator head. In order to actuate the fuel injection valve 1, an actuation voltage is applied to the actuator 23, causing the actuator 23 to expand in the axial direction 20. Since the transition piece 27 supports the actuator 23 against a housing part 28 that contains the through openings 6, 7, the actuation of the actuator 23 causes the transition piece 25 to slide in the axial direction 20 counter to the force of the valve spring 21 so that the valve closing element 17 lifts away from the valve seat surface 16, thus opening the sealing seat embodied between the valve seat surface 16 and the valve closing element 17. This initiates an injection of the fuel from the fuel chamber 8 through the annular gap 29 and the open sealing seat, into a combustion chamber (not shown) of an internal combustion engine.

After the actuation of the fuel injection valve 1, the actuator 23 contracts again so that the force of the valve spring 21 causes the valve needle 18 to return in the direction opposite the axial direction 20 into the initial position shown in FIG. 1, once again closing the sealing seat between the valve seat surface 16 and the valve closing element 17.

The fuel injection valve 1 has a stretch hood 30 that circumferentially encloses the actuator 23. The stretch hood 30 also encloses a part of the transition piece 27. At the other end, the stretch hood 30 also circumferentially encloses a part of the transition piece 25. The transition piece 25 has a region 31 in which it is adapted to the square shape of a cross section of the first end 24 of the actuator 23 so that the region 31 of the transition piece 25 is likewise embodied as square. Thanks to this adapted embodiment, the stretch hood 30 transitions from the actuator 23 to the transition piece 25 without sharp bends. The transition piece 25 also has a transition region 32 in which the cross-sectional form of the transition piece 25 transitions evenly from the square form in the region 31 to a circular cross-sectional form in a region 33. The region 33 is adjoined by a region 34 in which the transition piece 25 is conical, i.e. the cross section of the transition piece 25 in the region 34 decreases in the axial direction 20. The conical region 34 is adjoined by a region 35 in which the transition piece 25 is embodied as cylindrical. In the exemplary embodiment show the stretch hood 30 circumferentially encompasses the regions 31, 32, 33. In addition, the stretch hood 30 also circumferentially encompasses a part of the region 35 of the transition piece 25. Alternatively, it is also possible for the stretch hood 30 to circumferentially encompass only part of the region 34 of the transition piece so that the region 35 of the transition piece 25 remains uncovered.

In the region 34 in which the transition piece is conical, the stretch hood 30 rests against an outside 36 of the transition piece 25, thus producing a form-locked connection between the stretch hood and the transition piece 25 and thus preventing the stretch hood 30 from sliding counter to the axial direction 20. In order to fix the stretch hood 30 in place, a fastening ring 37 made of plastic or metal is provided, which acts on the stretch hood 30 with a fastening force in the radial direction against the region 34 of the transition piece 25. The above-describe embodiment of the connection between the stretch hood 30 and the transition piece 25 seals the interior of the stretch hood 30 that contains the actuator 23 and protects it from fuel contained in the actuator chamber 5, in particular from dirt particles in the fuel. In order to also achieve such a protection and such a seal in relation to the transition piece 27, a connection is also provided between the transition piece 27 and the stretch hood 30; a fastening ring 38 is also provided. This embodiment corresponds to the connection between the stretch hood 30 and the transition piece 25; the form-locked connection between the stretch hood 30 and the transition piece 27 prevents the stretch hood from sliding in the axial direction 20.

The stretch hood 30 is stretchable at least in a region 40 of the actuator 23 in order to permit an expansion of the stretch hood 30 in the axial direction 20 when the actuator 23 is actuated. The region 40 preferably extends along the entire actuator 23 and possibly also along the transition pieces 25, 27.

In any case, the attachment of the stretch hood 30 to the transition pieces 25, 27 protects the actuator from dirt particles and the like in the fuel. In order to additionally protect the actuator 23 from the potential entry of fuel, the actuator 23 can also be provided with a protecting and insulating layer, which can, for example, be composed of a lacquer, a film, or parylene. This further improves the protection of the actuator 23 from influences from the actuator chamber 5.

The above-described embodiment also has the advantage of a simple assembly. In it, the transition pieces 25, 27 can be attached to the actuator 23. Then, the stretch hood 30 can be pulled on over the actuator assembly and then laid in place over the assembly in a form-locked fashion. The fastening rings 37, 38 can then be used to fix the stretch hood 30 in position. As a result, the assembly requires only joining processes, thus making it possible to eliminate welded connections and screw connections. This also achieves a particularly compact design, in particular an optimized diameter, thus reducing the overall size of the fuel injection valve 1. Laying the stretch hood 30 against the actuator 23 also enables an advantageous dissipation of the generated heat into the fuel flowing through the actuator chamber 5. This also makes it possible to eliminate a cast element for heat removal.

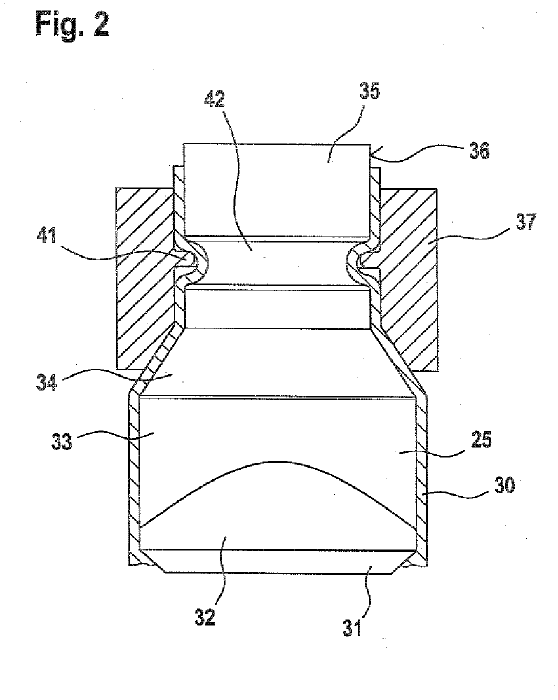

FIG. 2 shows a transition piece 25 of the fuel injection valve according to a second exemplary embodiment, embodied in the form of an actuator head. Corresponding elements in all the figures have been provided with matching reference numerals, thus eliminating the need for repeated description. The embodiment of the transition piece 27 embodied in the form of an actuator foot corresponds to that of the transition piece 25.

In the transition piece 25 shown in FIG. 2, the cylindrical region 35 is adjoined by a conical region 34; the cylindrical region 35 of the transition piece has a groove 42 extending radially around its circumference. In the radial direction, the groove 42 preferably has an at least approximately circular or elliptical cross section. However, the groove 42 can also have a rectangular or other cross section in the radial direction. The transitions here are preferably rounded.

The stretch hood 30 is introduced into the groove 42 and the stretch hood at least partially fits the geometry of the groove 42. In addition, the fastening ring 37 has a bead-shaped projection 41 extending radially around the circumference in the region of the groove 42 in order to hold the stretch hood 30 in the groove 42.

In this exemplary embodiment, the groove 42 is embodied in the form of a rounded channel 42 in the transition piece 35 into which the fastening ring 37—which is embodied with the fitted mating form and slightly clamps the stretch hood 30—is slid in order to mount it over the cylindrical region 42 of the transition piece and engages in detent fashion in the end position depicted in FIG. 2. The geometry of the fastening ring 37 is adapted to the cylindrical region 35, the conical region 34, and the groove 42 provided in the cylindrical region 35 of the transition piece, taking into account the wall thickness of the stretch hood 30. The form-locked engagement thus produced causes both the stretch hood 30 and the fastening ring 37 to remain fixed in position.

The fastening ring can also clamp the stretch hood in the groove 42 here with a slight tensile stress so that the parts of the fuel injection valve contained inside the stretch hood are positioned against one another, thus rendering it unnecessary to glue these parts to one another by means of an adhesive. Provided that the stretch hood 30 is embodied in the form of a shrink sleeve 30, the stretch hood 30 can be sick into place against the transition pieces 25, 27 immediately after being brought into position. A subsequent shrinkage of the stretch hood 30 also in the region lying between the transition pieces 25, 27 then generates a force for holding together the parts of the fuel injection valve 1 contained inside the shrink hood and generates a tensile stress acting on the shrink hood in the region of the groove 42.

The fastening ring 37 can be comprised of one or more materials. In particular, a polymer, especially a possibly glass fiber-reinforced polyamide and/or a metal can be used, which is/are able to withstand exposure to surrounding fluids, in particular the fuel.

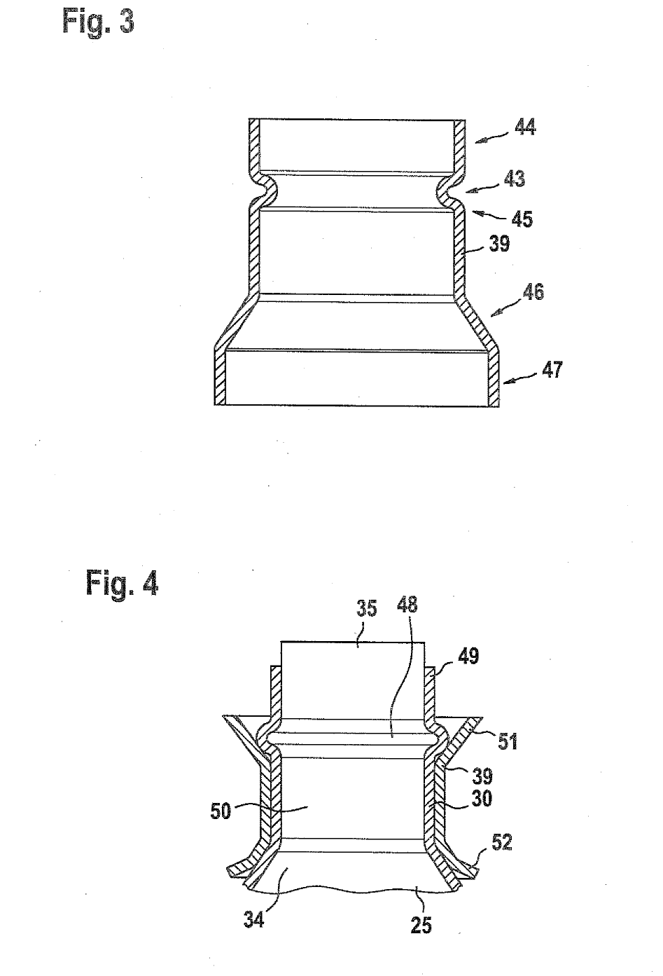

FIG. 3 shows an axial section through a fastening sleeve 39 of the fuel injection valve 1 according to a third exemplary embodiment. The fastening sleeve 39 can be used in lieu of the fastening ring 37 that is provided in the fuel injection valve 1 according to the exemplary embodiment shown in FIG. 2.

The fastening sleeve 39 has a bead 43 that presses the shrink hood 30 into the groove 42 in order to produce a reliable connection of the shrink hood 30 to the transition piece 25. Adjoining the bead 43, the fastening sleeve 39 also has regions 44, 45 that are fitted to the cylindrical region 35 in order to guide the shrink hood 30 between the fastening sleeve 39 and the transition piece 25. In addition, the fastening sleeve 39 is conical in a region 46 in order to clamp the shrink hood 30 between the fastening sleeve 39 and the conical region 34 of the transition piece 25. The region 46 is adjoined by a region 47 of the fastening sleeve 39 in which the fastening sleeve 39 has a preferably constant diameter that is adapted to the region 33 of the transition piece 25. The fastening sleeve 39 protects the shrink hood 30 in the region 47. In addition, this also makes it possible to assure that the shrink hood 30 rests against the transition piece 25.

The fastening sleeve 39 can be composed of sheet metal. The bead 43 constitutes a constriction 43 that can be produced by means of stamping. This can also serve to produce constrictions 43 in the circumference direction in only some areas.

FIG. 4 shows a sample sectional view of a transition piece 25 of a fuel injection valve 1 according to a fourth exemplary embodiment of the invention.

In this exemplary embodiment, the transition piece 25 has a bead 48 extending radially around the circumference, which produces a protrusion 48. The bead 48 is provided in lieu of the groove 42 on the transition piece 25 shown in FIG. 2.

However, in lieu of the bead 48 or the groove 42, it is also possible for a number of beads or grooves to be provided. It is also possible for a transition piece 25 to be provided with a combination of one or more beads 48 and one or more grooves 42.

At its end 49, the stretch hood 30 is pulled or guided at least slightly past the bead 48 in order to assure a fastening in the axial direction even after a possible slippage of the stretch hood 30. In addition, a fastening sleeve 39 is provided that encompasses the transition piece 25 at least in the region 50 between the bead 48 and the conical region 34. In addition, the fastening sleeve 39 has flared ends 51, 52, with the end 51 extending at least slightly beyond the bead 48 in the axial direction and with the end 52 extending at least slightly into the conical region 34 in the axial direction. This produces an elastic prestressing of the fastening sleeve 39 that clamps the shrink hood 30 on the one hand between the bead 48 and the fastening sleeve 39 and on the other hand, between the conical region 34 of the transition piece 25 and the fastening sleeve 39. This assures a reliable attachment of the shrink hood 30 to the transition piece 25.

The end 51 of the fastening sleeve 39 constitutes a flared piece 51 that is adapted to the bead 48. The flared piece 51 represents one embodiment, which, by contrast with the embodiment shown in FIG. 3, is provided with a constriction 43 that is formed by the crease 43, In lieu of a flared end 51, it is also possible to provide a widened region 51 in which the fastening sleeve 39 rests against the shrink hood 30 on both sides of the bead 48 and encloses the region 35 of the transition piece. The ends 51, 52 of the fastening sleeve 42 can also be embodied in the form of cylinders.

The invention is not limited to the exemplary embodiments described above.

1-16. (canceled)

17. A fuel injection valve for fuel injection systems of air-compressing autoignition internal combustion engines, the valve comprising an actuator contained in a valve housing, a valve seat, a valve needle, a valve closing element that the actuator is capable of actuating by means of the valve needle and that cooperates with the valve seat surface to form a sealing seat, at least one transition piece attached to the actuator, and at least one stretch hood circumferentially encompassing the actuator and circumferentially encompassing at least part of the transition piece, the stretch hood being at least indirectly attached to the transition piece in a fastening region of the transition piece.

18. The fuel injection valve according to claim 17, wherein the stretch hood has the capacity to stretch in an axial direction in at least one region of the actuator in order to permit an expansion of the actuator in the axial direction for actuation of the valve closing element.

19. The fuel injection valve according to claim 17, wherein the transition piece is adapted to a cross-sectional form of the actuator on a side on which the transition piece is attached to the actuator, and wherein the transition piece is embodied as rounded in the fastening region in which the stretch hood is attached to the transition piece.

20. The fuel injection valve according to claim 18, wherein the transition piece is adapted to a cross-sectional form of the actuator on a side on which the transition piece is attached to the actuator, and wherein the transition piece is embodied as rounded in the fastening region in which the stretch hood is attached to the transition piece.

21. The fuel injection valve according to claim 19, wherein the transition piece is embodied so that starting from the side on which the transition piece is attached to the actuator, a cross-sectional form of the transition piece transitions evenly into a cross-sectional form in the fastening region of the transition piece.

22. The fuel injection valve according to claim 17, wherein the transition piece is embodied as cylindrical in the fastening region.

23. The fuel injection valve according to claim 17, wherein the transition piece is embodied as conical in at least part of the fastening region.

24. The fuel injection valve according to claim 21, wherein the transition piece is embodied as conical in at least part of the fastening region.

25. The fuel injection valve according to claim 23, wherein the transition piece is embodied at least approximately in the form of a truncated cone in at least part of the fastening region.

26. The fuel injection valve according to claim 24, wherein the transition piece is embodied at least approximately in the form of a truncated cone in at least part of the fastening region.

27. The fuel injection valve according to claim 23, wherein the stretch hood rests circumferentially against the transition piece in the fastening region.

28. The fuel injection valve according to claim 25, wherein the stretch hood rests circumferentially against the transition piece in the fastening region.

29. The fuel injection valve according to claim 27, wherein the stretch hood is attached in a form-locked fashion to the transition piece in the fastening region.

30. The fuel injection valve according to claim 17, further comprising a fastening element, which at least partially encloses the stretch hood and the transition piece and fastens the stretch hood to the transition piece in the fastening region.

31. The fuel injection valve according to claim 30, wherein the transition piece comprises a groove extending radially around its circumference, wherein the fastening element comprises a projection, and wherein the projection of the fastening element secures the stretch hood in the groove of the transition piece.

32. The fuel injection valve according to claim 31, wherein the groove is provided in a cylindrical region of the transition piece.

33. The fuel injection valve according to claim 10, wherein the transition piece comprises a bead extending radially around its circumference, wherein the fastening element has a widened region, and wherein the stretch hood is clamped between the fastening element and the bead of the transition piece, at least in the vicinity of the widened region.

34. The fuel injection valve according to claim 33, wherein the bead is provided in a cylindrical region of the transition piece.

35. The fuel injection valve according to claim 17, wherein the transition piece is embodied in the form of an actuator head or an actuator foot.

36. The fuel injection valve according to claim 17, wherein the transition piece is attached to one end of the actuator and an additional transition piece is provided, which is attached to another end of the actuator.
